(19) United States
(12) Patent Application Publication
(10) Pub. No.: US 2012/0081256 A1
(43) Pub. Date: Apr. 5, 2012

(54) ANTENNA APPARATUS

(76) Inventors: Toshiaki AIZAWA, Akita (JP); Tomohiro Shinkawa, Akita (JP); Junichi Noro, Akita (JP)

(21) Appl. No.: 13/238,412

(22) Filed: Sep. 21, 2011

(30) Foreign Application Priority Data
Oct. 4, 2010 (JP) 2010-224711

(51) Int. Cl. H01Q 11/12; H01Q 7/00

(52) U.S. Cl. 343/741; 343/866

(57) ABSTRACT

An antenna apparatus is provided with an antenna cover formed so as to widen toward the rear and to rise in a streamlined shape toward the rear along the longitudinal central axis, an antenna base to which the antenna cover is attached in a watertight fashion, and an antenna section accommodated in a space formed by the antenna cover and the antenna base. The antenna section is set upright on the antenna base, and has a configuration in which an antenna wire of predetermined length corresponding to a frequency band of medium frequency wave to very high frequency wave is wound vertically at a predetermined inter-wire pitch around a winding member accommodated in a space corresponding to the raised section of the antenna cover.

### CROSS REFERENCE TO RELATED APPLICATIONS

This application is entitled to and claims the benefit of Japanese Patent Application No. 2010-224711, filed on Oct. 4, 2010, the disclosure of which including the specification, drawings and abstract, is incorporated herein by reference in its entirety.

### TECHNICAL FIELD

The present invention relates to an antenna apparatus, and more particularly to a sharkfin antenna apparatus capable of receiving medium frequency waves to very high frequency waves (300 kHz to 300 MHz) such as AM/FM broadcast waves.

### BACKGROUND ART

Conventionally, a telescopic rod type of antenna (hereinafter referred to as “rod antenna”) is generally used as a vehicular antenna apparatus capable of receiving AM/FM broadcast waves. The element length (rod length) of such a rod antenna is made approximately ¼ of wavelength λ of an FM wave (for example, 1.5 m in the case of a 50 MHz resonance frequency). In this case, an antenna element compatible with an FM wave frequency band is applied to AM wave reception, and the resonance frequency does not match, and therefore an AM wave resonant circuit and amplifier circuit are used to secure sensitivity. Also known is an antenna (hereinafter referred to as “helical antenna”) with an antenna length shortened to approximately 200 to 400 mm by winding an antenna element (conductive wire) around an insulating rod in a helical fashion.

Meanwhile, a composite-type vehicular antenna apparatus has been proposed that is capable of receiving radio waves of a plurality of frequency bands for GPS Global Positioning System), mobile phone, remote engine starter, and suchlike use (see Patent Reference, for example). An antenna apparatus described in Patent Reference is called a sharkfin type (hereinafter “sharkfin antenna”) because of its external shape.

An above-described rod antenna (or helical antenna) is installed projecting from a vehicle, and therefore detracts from the external appearance of the vehicle, as well as being susceptible to bending or breakage in the event of the rod hitting an obstacle when parking in a parking area in which there is an obstacle such as a roof. Also, since a rod antenna has a long antenna length, wind noise is generated when the vehicle is in motion, which is annoying for the driver and/or passengers. Moreover, a further problem with a rod antenna is that it is comparatively easily detached, and susceptible to theft. Since a sharkfin antenna has a lower antenna height than a rod antenna (or helical antenna), it can solve the above problems, achieving a sense of integration with a vehicle and improving the vehicle's external appearance, for example. A further advantage is that the number of antenna components is smaller, enabling cost to be reduced compared with a rod antenna.

Patent Reference: Japanese Patent Publication No. 2009-514253

However, since the antenna height of a sharkfin antenna is low and internal accommodation space is limited, it is difficult to accommodate a comparatively long antenna element for AM/FM broadcast reception. Also, although there are sharkfin antennas in which an antenna pattern is affixed to the inner surface of the sharkfin-shaped antenna cover, a sufficient element length cannot be secured, with the result that reception sensitivity is significantly lower than with a rod antenna, and practicability is poor. Consequently, rod antennas or helical antennas are still the mainstream types of antenna apparatuses for AM/FM broadcast reception.

It is therefore an object of the present invention to provide an antenna apparatus of excellent design that is capable of receiving medium frequency waves to very high frequency waves such as AM/FM broadcast waves with good sensitivity.

### SUMMARY OF THE INVENTION

In order to achieve the above object, an antenna apparatus of the present invention is provided with: an antenna cover formed so as to widen toward the rear, and to rise in a streamlined shape toward the rear along the longitudinal central axis; an antenna base to which the antenna cover is attached in a watertight fashion; and an antenna section accommodated in a space formed by the antenna cover and the antenna base, and, in this antenna apparatus, the antenna section is set upright on the antenna base, and has a configuration in which an antenna wire of predetermined length corresponding to a frequency band of medium frequency wave to very high frequency wave is wound vertically at a predetermined inter-wire pitch around a winding member accommodated in a space corresponding to a raised section of the antenna cover.

According to the present invention, a sufficient element length can be secured, enabling medium frequency waves to very high frequency waves such as AM/FM broadcast waves to be received with good sensitivity. Also, since an antenna apparatus of the present invention is of sharkfin type, the design is improved and disadvantages of a rod antenna can be eliminated. Therefore, an antenna apparatus of excellent design is provided that is capable of receiving medium frequency waves to very high frequency waves such as AM/FM broadcast waves with good sensitivity.

### BRIEF DESCRIPTION OF THE DRAWINGS

FIG. 1 is an outline drawing of an antenna apparatus according to an embodiment of the present invention;

FIG. 2 is a drawing showing the internal structure of an antenna apparatus according to an embodiment of the present invention; and

FIG. 3 is an enlarged view of an AM/FM broadcast antenna section.

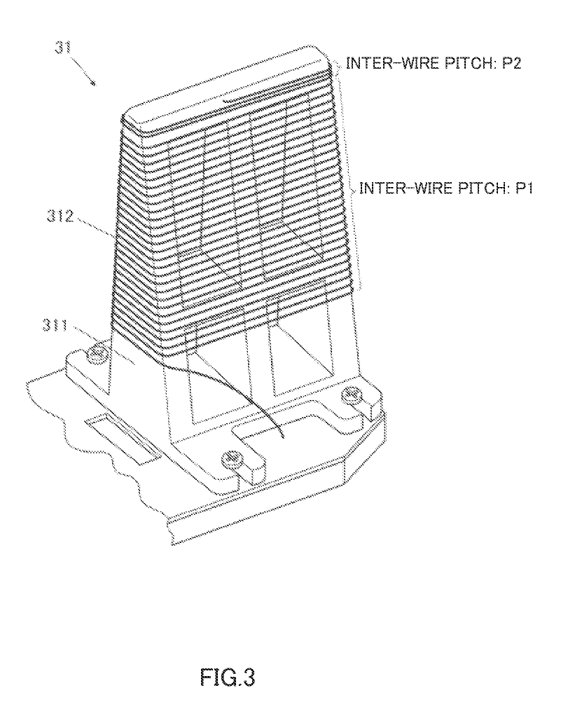

### DETAIL DESCRIPTION OF PREFERRED EMBODIMENTS

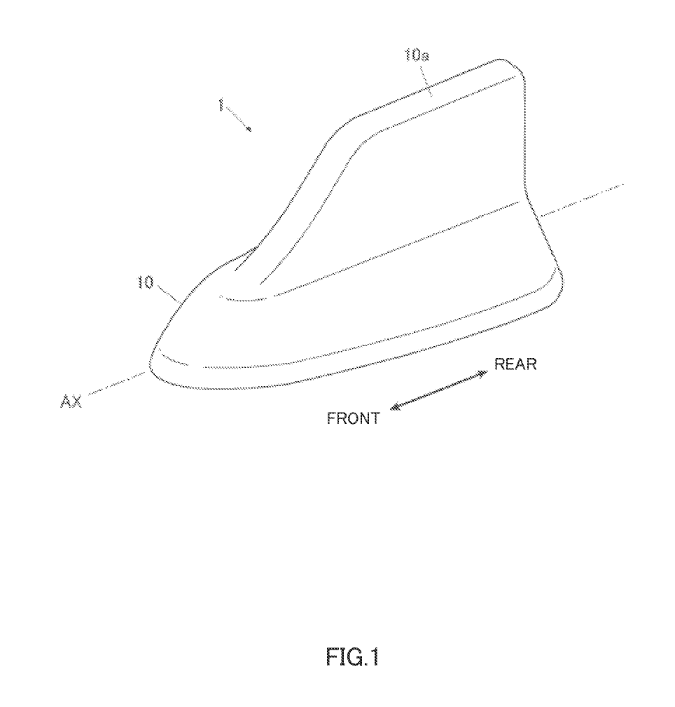

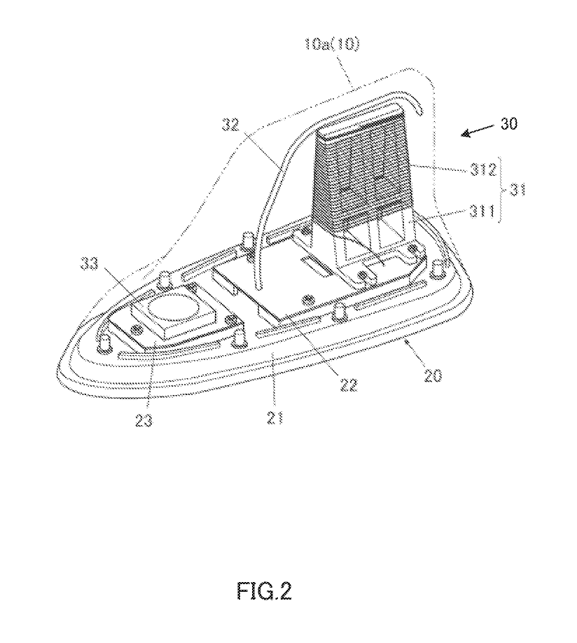

Now, an embodiment of the present invention will be described in detail with reference to the accompanying drawings. FIG. 1 is a drawing showing the external appearance of an antenna apparatus according to an embodiment of the present invention, and FIG. 2 is a drawing showing the internal structure of the antenna apparatus. Antenna apparatus 1 of this embodiment is a composite-type antenna apparatus that is capable of receiving radio waves of a plurality of frequency bands for GPS, digital TV broadcasting, AM/FM broadcasting, and suchlike use, and is fixed to an installation surface such as the roof of a vehicle, for example.

As shown in FIG. 1 and FIG. 2, antenna apparatus 1 comprises antenna cover 10, antenna base 20, and antenna section 30. Antenna cover 10 is made of synthetic resin, for example, and is formed so to widen toward the rear and rise in a streamlined shape toward the rear along longitudinal central axis AX. For example, the external dimensions of antenna cover 10 (antenna apparatus 1) are length: 145 mm, width: 75 mm, and height: 60 mm; and the external dimensions of raised section 10a are length: 70 mm, width: 20 mm, and height: 35 mm. That is to say, antenna cover 10 is formed in a low-profile sharkfin shape that does not detract from the external appearance of a vehicle. Antenna cover 10 is a thin molded component open at the bottom, and when antenna base 20 is fitted into the bottom aperture, an antenna section 30 accommodation space is formed.

Antenna base 20 is provided with base member 21, and antenna boards 22 and 23 set on the upper surface of this base member 21 and electrically connected to base member 21. Base member 21 is, for example, metallic, and has a shape matching the lower surface aperture of antenna cover 10. A resin protective member is provided around base member 21, and can fit together with antenna cover 10 in a watertight fashion. Although not shown in the drawings, a downward projection is formed on the bottom surface of base member 21. Antenna apparatus 1 is fixed to an installation surface (vehicle roof or the like) by inserting this projection into a fixing aperture (not shown) formed in the installation surface and sandwiching the installation surface between base member 21 and a fixing member (not shown). At this time, base member 21 is electrically connected to the installation surface, and is grounded via the body of the vehicle.

Antenna boards 22 and 23 have tuning circuitry and amplification circuitry for selectively receiving only a radio wave of a specific frequency, and are fixed to the upper surface of base member 21 by means of screws, for example. Antenna section 30 is mounted on these antenna boards 22 and 23. A feeder cable (not shown: for example, a coaxial cable) is connected to antenna boards 22 and 23, and power generated by reception of a radio wave by antenna section 30 is transmitted to a receiver installed inside the vehicle via this feeder cable.

Antenna section 30 comprises radio antenna 31 capable of receiving AM/FM broadcast waves, DTV antenna 32 capable of receiving a digital TV broadcast wave, GPS antenna 33 capable of receiving a GPS radio wave, and so forth.

Radio antenna 31 is configured by antenna wire 312 that is an antenna element being wound vertically at a predetermined inter-wire pitch around winding member 311. Winding member 311 is a member made of synthetic resin, for example, whose bottom surface lies sideways along a triangle pole of an isosceles triangle, and is set upright with respect to antenna board 22. In winding member 311, a plurality of grooves are formed in the antenna wire 312 winding surface, and antenna wire 312 can easily be wound at a predetermined inter-wire pitch. Here, in order to improve performance as an antenna, such as ease of tuning and reception sensitivity, it is desirable to widen the inter-wire pitch of antenna wire 312 as far as possible, and increase the antenna height. Consequently, winding member 311 is formed so as to be as high as possible, and to be as long as possible circumferentially, according to the space formed by raised section 10a of antenna cover 10.

Antenna wire 312 is, for example, insulation-sheathed enamel wire with an outer diameter of 0.3 mm, having a length (for example, 1.5 m) corresponding to an FM broadcast frequency band (76 to 108 MHz). One end of antenna wire 312 is connected to a feeding point of antenna board 22, and the other end is fixed to winding member 311. Medium frequency waves to very high frequency waves (300 kHz to 300 MHz) can be received by means of this antenna wire 312. In radio antenna 31, a predetermined turn of antenna wire 312 is wound around winding member 311 at first inter-wire pitch P1 from the lower end, and an upper-end number of turns are wound at second inter-wire pitch P2 differing from first inter-wire pitch P1. In this embodiment, second inter-wire pitch P2 is set narrower than first inter-wire pitch P1, but it may also be set wider. Inter-wire pitches P1 and P2 are decided as appropriate according to the height if radio antenna 31 and the length of antenna wire 312. By partially changing the inter-wire pitch in this way, the resonance frequency of radio antenna 31 can easily be adjusted, and radio antenna 31 can be given a simple structure.

As an extreme case, it does not matter if antenna wire 312 is wound tightly (inter-wire pitch: 0), but spacing of 3 mm or more is desirable in terms of antenna performance. Also, contrary to this embodiment, provision may also be made for a predetermined turn to be wound around winding member 311 at first inter-wire pitch P1 from the upper end, and a lower-end number of turns to be wound at second inter-wire pitch P2 differing from first inter-wire pitch P1.

DTV antenna 32 is, for example, a metallic rod-shaped member, having a length (for example, 130 mm) corresponding to a digital TV broadcast frequency band (470 to 770 MHz). DTV antenna 32 has one end connected to a feeding point of antenna board 22, and extends along the upper border of the inner surface of raised section 10a of antenna cover 10. GPS antenna 33 is a patch antenna with a resonance frequency of approximately 1.5 GHz, and is connected to antenna board 23.

Antenna apparatus 1 is assembled by fitting antenna cover 10 from above onto antenna base 20 on which antenna section 30 is mounted. Antenna section 30 is accommodated in the space formed by antenna cover 10 and antenna base 20.

Thus, antenna apparatus 1 is provided with antenna cover 10 formed so as to widen toward the rear and rise in a streamlined shape toward the rear along the longitudinal central axis, antenna base 20 to which antenna cover 10 is attached in a watertight fashion, and antenna section 30 (radio antenna 31) accommodated in the space formed by antenna cover 10 and antenna base 20. Antenna section 30 (radio antenna 31) is set upright on antenna base 20 (antenna board 22), and has a configuration in which antenna wire 312 of predetermined length corresponding to a very high frequency wave frequency band is wound vertically at predetermined inter-wire pitches P1 and P2 around winding member 311 accommodated in a space corresponding to raised section 10a of antenna cover 10.

According to antenna apparatus 1, a sufficient element length can be secured, enabling medium frequency waves to very high frequency waves such as AM/FM broadcast waves to be received with good sensitivity. Also, since antenna apparatus 1 is of sharkfin type, the design is improved and disadvantages of a rod antenna can be eliminated. That is to say, since antenna apparatus 1 has a low-profile sharkfin shape, it does not detract from the external appearance of a vehicle, and there is no risk of damage to antenna apparatus 1 caused by hitting an obstacle when parking in a parking area having an obstacle such as a roof. Furthermore, antenna apparatus 1 does not generate wind noise when a vehicle is in motion, and is effective in preventing theft. Therefore, an antenna apparatus of excellent design is provided that is capable of receiving medium frequency waves to very high frequency waves such as AM/FM broadcast waves with good sensitivity.

An invention devised by the present inventors has been described above in concrete terms based on an embodiment, but the present invention is not limited to the above embodiment, and modifications are possible without departing from the scope of the present invention.

For example, the external dimensions of antenna apparatus 1 can be freely designed insofar as a sharkfin design is not lost. Also, the shape of winding member 311 of radio antenna 31 is not limited to that shown in this embodiment, and can be a tabular shape of uniform thickness in the vertical direction, or an oval or elliptical columnar shape. Furthermore, a plurality of radio antennas 31 having different performance may be arrayed in the longitudinal or crosswise direction. Moreover, a mobile phone, remote engine starter, or satellite radio (SDARS: Satellite Digital Audio Radio Service) antenna may be installed in antenna apparatus 1 instead of, or in addition to, DTV antenna 32 or GPS antenna 23.

The embodiment here disclosed should be considered as an example in all respects, and not as being restrictive. The scope of the present invention is shown not by the above description but by the accompanying claims, and is intended to include all meanings equivalent to the claims and modifications within the scope thereof.

What is claimed is:

1. An antenna apparatus comprising:
an antenna cover having a width increasing rearward, said antenna cover including a raised section formed in a streamlined shape rising rearward along a longitudinal central axis thereof;
an antenna base attached to the antenna cover in a watertight fashion; and
an antenna section accommodated in the antenna cover,
wherein said antenna section is disposed upright on the antenna base, and includes a winding member accommodated in the raised section and an antenna wire having a predetermined length corresponding to a frequency band of a medium frequency wave to a very high frequency wave, said antenna wire being wound around the winding member vertically at a predetermined inter-wire pitch.

2. The antenna apparatus according to claim 1, wherein said antenna wire is wound at a first inter-wire pitch from one end thereof, and is wound at a second inter-wire pitch differing from the first inter-wire pitch from the other end thereof for several turns.

3. The antenna apparatus according to claim 1, wherein said antenna section is arranged to be capable of receiving AM/FM broadcast waves.
